(19) United States
(12) Patent Application Publication
(10) Pub. No.: US 2024/0281912 A1
(43) Pub. Date: Aug. 22, 2024

(54) ELECTRONIC NOTARY JOURNAL

(71) Applicant: Jimmy Wagner, Brooklyn, NY (US)

(72) Inventor: Jimmy Wagner, Brooklyn, NY (US)

(21) Appl. No.: 18/454,634

(22) Filed: Aug. 23, 2023

Related U.S. Application Data
(60) Provisional application No. 63/447,286, filed on Feb. 21, 2023.

(51) Int. Cl. G06Q 50/18; G06F 9/451

(52) U.S. Cl. CPC G06Q 50/18; G06F 9/451

(57) ABSTRACT

A system and method for electronically managing notarization journal by notary public and electronically verifying details of a signers and witnesses including identity documents against a third-party database. The details of document being notarized and signers and witnesses party to the making of the document can be electronically managed as a record. Any saved records can be later retrieved and published as desired by the public notary.

### CROSS-REFERENCE TO RELATED APPLICATIONS

This application claims priority from a U.S. Provisional Patent Application Ser. No. 63/447,286, filed on Feb. 21, 2023, the disclosure of which is incorporated herein by reference in their entirety.

### FIELD OF INVENTION

The present invention relates to a system and method for creating and maintaining an electronic notary journal, and more particularly, the present invention relates to a system and method for verifying presented identifications, self-populating the electronic journal, and maintaining signatures.

### BACKGROUND

Notary public refers to a person appointed by a state government for serving the public as an impartial witness when important documents have to be signed. Many of the documents to be submitted for legal or governmental works must be notarized i.e., signed by the parties in the presence and witnessed by the notary public. Similarly, certain contracts for legal enforceability may require that the contract be in written form and notarized.

In the United States, many states require the notary public to very identifications and maintain journals for every transaction i.e., notarization. Notary Publics in New York State and around the Country must keep records, logs, and journals of their notarization work for a period of up to ten years. These entries include ID and type, document and type, and signature of signer and witness alike. Moreover, some states even require keeping a record of finger or thumbprints.

However, verification of identity cards, recording of the transaction, and maintaining physical records are tedious and time-consuming processes. Moreover, manual record-keeping may often lead to accidental loss or damage to the journals.

Moreover, a notary public has to carry heavy journals with them which may not always be possible and may also lead to loss or damage to the journals.

A need is therefore appreciated for a system and method that can verify the identity cards and can maintain a notary journal in an electronic form.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for verifying identity proofs and electronically maintaining a notary journal.

It is another object of the present invention that the process is efficient and economical.

It is still another object of the present invention that the system and method save time in record keeping.

It is yet another object of the present invention that system and method allow maintaining compliance with legal requirements.

It is a further object of the present invention that system and method allow finding records quickly and easily in a variety of ways.

It is still a further object of the present invention that the system and method allow for saving paper.

It is yet a further object of the present invention that the system and method make the process convenient for signers and witnesses.

It is an additional object of the present invention that the system and method allow for capturing all the required information.

It is still an additional object of the present invention that the system and method allow for maintaining the records in a trustworthy manner.

It is yet an additional object of the present invention that the system and method allow for verifying the identity cards of signers and witnesses.

In one aspect, disclosed is a system and method for electronically verifying an identity card and managing an electronic notary journal, the system comprising a processor and a memory. The method comprising creating, a new journal entry, through a first screen of an interface, by receiving details for a document to be notarized, the detail of the document comprises nature of the document and fee; adding, at least one signer, through a second screen of the interface, wherein details of a first signer of the at least one signer are received through the second screen; capturing, an image of an identity document of the first signer through a third screen, wherein closing the third screen automatically opens a fourth screen of the interface; receiving, through the fourth screen, electronically, a signature of the first signer, wherein saving the signature automatically closes the fourth screen and opens the second screen, the second screen shows the added first signer; and verifying the identity document and the details of a first signer against an external database. The method further comprises adding one or more witnesses through a fifth screen of the interface, wherein details of a first witness of one or more witnesses are received through the fifth screen, an identity document of the first witness is received through the third screen, and a signature of the first witness is electronically received through the fourth screen.

In one aspect, the added first signer and the first witness are shown on the second screen. The method further comprises verifying the details of the first witness and the identity document of the first witness against the external database.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing an environment of a system, according to an exemplary embodiment of the present invention.

FIG. 2 is a block diagram showing the architecture of the system, according to an exemplary embodiment of the present invention.

FIG. 3a shows a registration screen and FIG. 3b shows a login screen of an interface, according to an exemplary embodiment of the present invention.

FIG. 4 shows a dashboard screen of the interface, according to an exemplary embodiment of the present invention.

FIG. 5 shows a log screen of the interface for entering a record, according to an exemplary embodiment of the present invention.

FIG. 6 shows the log screen after entering a witness, according to an exemplary embodiment of the present invention.

FIG. 7 shows a signer info screen for adding a signer, according to an exemplary embodiment of the present invention.

FIG. 8 shows a camera screen to capture a photograph of an identification document, according to an exemplary embodiment of the present invention.

FIG. 9 shows a signature screen for capturing a sign, according to an exemplary embodiment of the present invention.

FIG. 10 shows a witness info screen adding a witness, according to an exemplary embodiment of the present invention.

FIG. 11 shows an overview screen of the interface, according to an exemplary embodiment of the present invention.

FIG. 12 shows a profile screen of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for electronic maintenance of notary journals meeting all the legal and administrative compliances and rules for notary publics. The disclosed system and method allow the notary public to successfully verify and capture all required details from the clients and witnesses for keeping the journal. The records can be safely and electronically stored in a trustworthy environment for any desired period, such as the duration required by state laws. For example, most of the states require keeping the records for 10 years. The disclosed system can keep the records stored in the digital environment economically and more safely than manual record keeping. The disclosed system and method can also incorporate the trustworthiness of blockchain and like technologies as a safeguard against data tampering and hacks. The data can be remotely stored, for example, on cloud servers, and can be made accessible to the user from anywhere.

The disclosed system can also have an advantage over manual record keeping in that the information captured can be cross-verified from government databases in near real-time, thus reducing fraud. The disclosed system can be accessed through a portable user device, such as a smartphone allowing freedom from carrying heavy logbooks. The user device can be carried in a pocket and used as desired by the user. Thus, the disclosed system may act as a portable assistant to a notary public.

The term “user” herein refers to a person wishing to or using the disclosed system for record-keeping and ID verification; and includes notary publics. The term notary public and user are also interchangeably used herein.

The disclosed system can also provide for indexing the records, so that any record can be located using a variety of ways in a database, for example, using keywords, date, year, location, and the like. Moreover, the disclosed system can capture additional details that may be useful in a legal proceeding, such as the GPS location of a place where a record is received by the disclosed system. Date and time information from the system can also be stamped with each record. Any modifications can be tracked and maintained as a log.

The disclosed system and method can prove to be a big help to the notary and society at large maintaining the necessary record integrity associated with the important role notaries play for foundational document authentication. Using the disclosed system and method, the notary can verify the presented identifications of all parties involved. The Notary can secure all the relevant information needed for their legal record-keeping requirements as per their state and then safely store that information remotely for ten-plus years in preparation for any document audit or litigation over the document's authenticity.

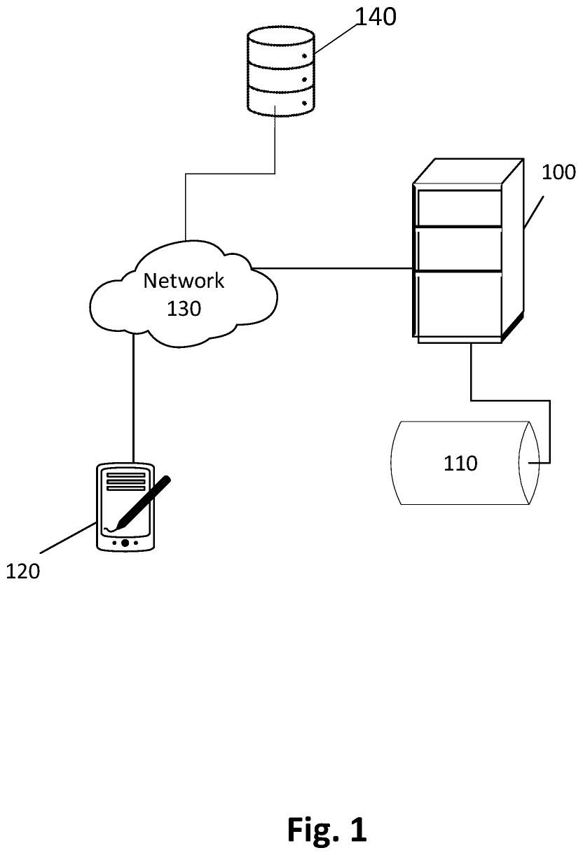

Referring to FIG. 1 which is a block diagram showing an environment of the disclosed system. The system 100 can connect to a user device 110 through a network 120. The user device can be a smartphone, laptop, desktop, and like. The user device at least includes a camera to capture a photograph and a network circuitry for connecting to the network. The user device can also include a display for presenting information and an input device for receiving the information. The system can also connect to a third-party database server 140 for identification verification. Examples of such third-party database servers include government records.

The network can be a wired network, a wireless network, or a combination of the wired network and the wireless network. Examples of the network include local area networks, wide area networks, internet, Wi-Fi, Wi-max, Cellular network, and the like. Also, while FIG. 1 shows a single-user device connected to the system through a single network, it should be understood that the multiple-user devices can connect with the disclosed system through multiple networks simultaneously and at different times. Moreover, a single-user device can connect with the disclosed system through a combination of wired and wireless networks. For example, through a Wi-Fi and optical cable network.

The system can be implemented in the form of servers that can be located at one location or geographically dispersed. The servers include cloud servers. The servers can support technologies of blockchain, public ledger, and the like.

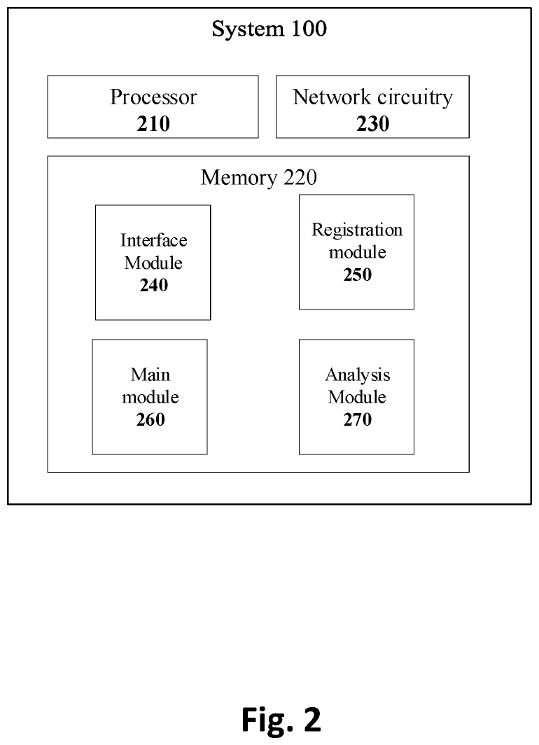

Referring to FIG. 2 which shows an architecture of the disclosed system 100. The system can include a processor 210 and a memory 220. The processor can be any logic circuitry that responds to, and processes instructions fetched from the memory. The memory may include one or more memory chips capable of storing data and allowing any storage location to be directly accessed by the processor. The system may also include a network circuitry 230 for connecting to the network 130. It is understood that the term processor includes one or more processors, and memory can include more than one memory unit. The memory includes modules according to the present invention for execution by the processor to perform one or more steps of the disclosed methodology. The module can be a program code, software code, algorithm, and the like that can be executed by the processor for performing one or more steps of the disclosed methodology.

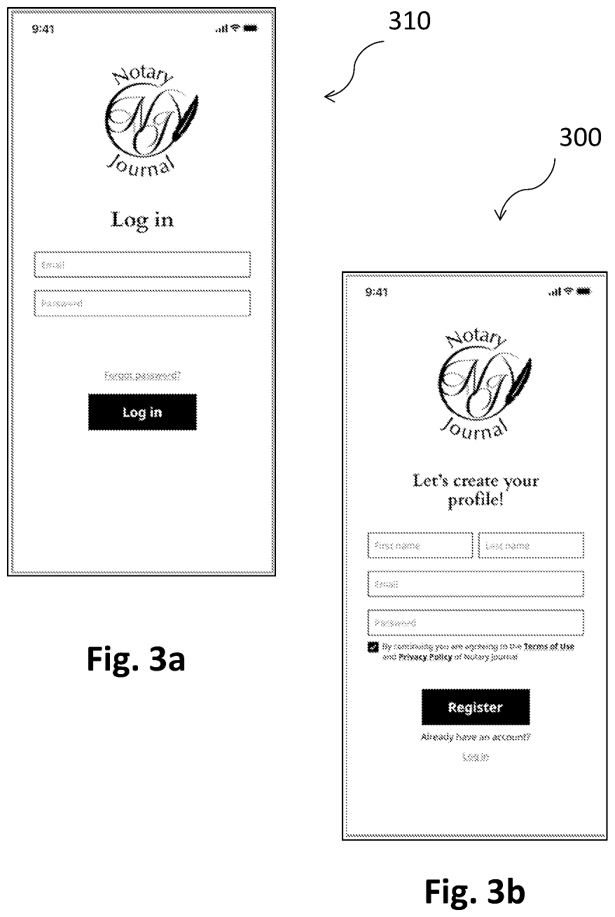

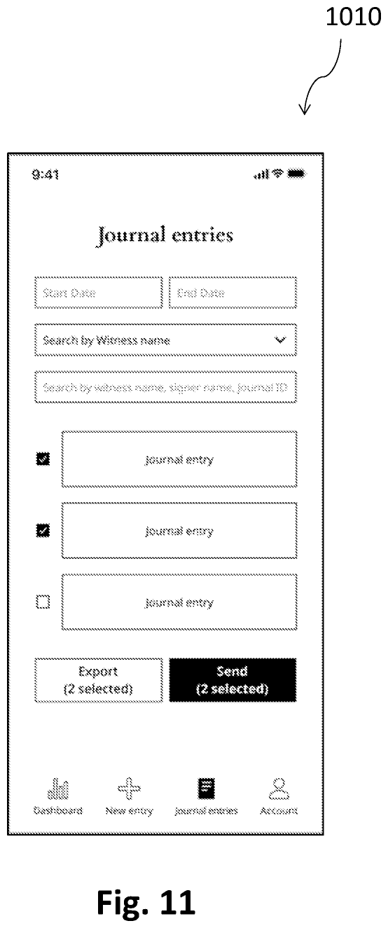

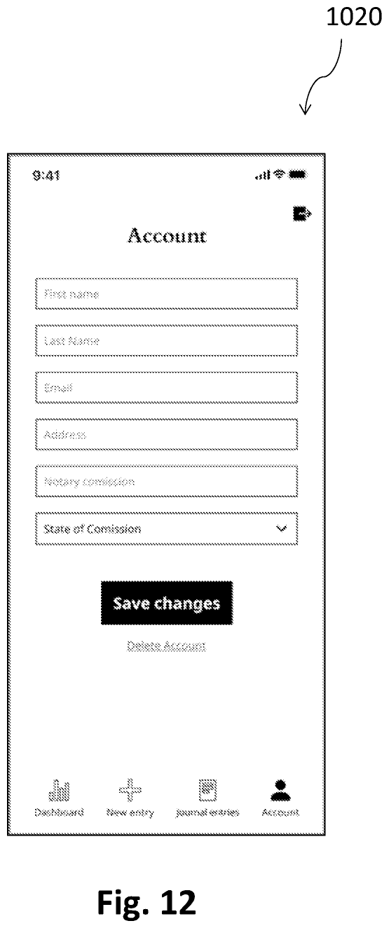

FIG. 2 shows the memory including an interface module 240 which upon execution by the processor provides an interface on a user device for interacting with the disclosed system. Through the interface, information can be presented on the user device and information can be received from the user device by the system. FIGS. 3-12 show different screens of the interface according to an exemplary embodiment of the present invention. The novel interface allows one to quickly navigate through different sections to quickly capture all the required information.

The memory may also include a registration module 250 that allows for registering a user with the disclosed system. The notary public can use the disclosed system for electronically managing the notary journals and verifying the identification cards. A main module 260 is also shown in FIG. 2 which upon execution by the processor allows capturing information from the parties and witnesses. The system may also include an analysis module 270 that upon execution of the processor allows for the searching of entries and records in a database and help meet any legal or administrative compliance.

The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interaction with a user through the user device, wherein information can be presented within the user interface by the system 100 and information can be received by system 100 from the user.

The registration module may allow a user to register with the disclosed system. The registration module may also allow a registered user to safely and securely login into the disclosed preventing any unauthorized access to the disclosed system. Any user willing to use the disclosed can sign up using registration a screen 300 as shown in FIG. 3b through the registration module. The user can provide basic details such as name, address, and contact details. Once registered, the registration module can provide login details, such as username and password to the user for securely accessing the disclosed system. The password can be an alphanumeric code, biometric-based, token-based, or a combination thereof. The user can also be provided with an option to reset the password anytime, such as by generating a new password. Once login, the user can create their profile, including the type of notary, such as notary commission or state of commission. The user can enter their certification details as a notary which may be verified by the system in a back-end process. However, such a step may be optional. The user can log in using their credentials through login screen 310 also shown in FIG. 3a.

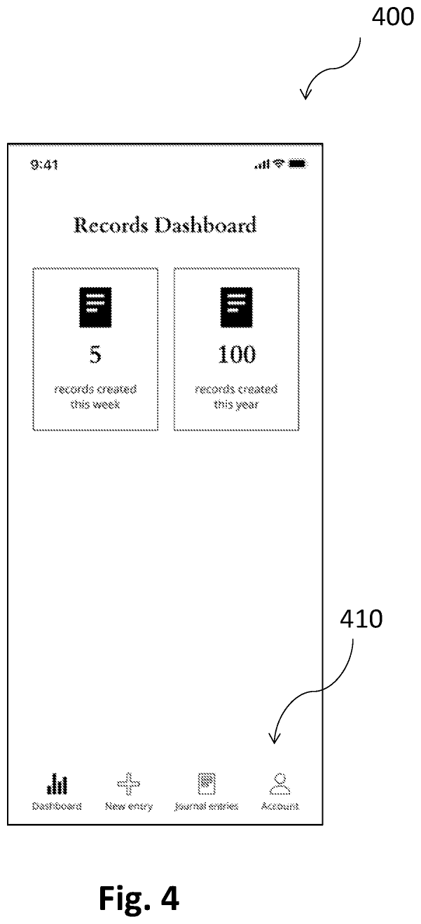

Upon login, a dashboard screen 400, shown in FIG. 4, can be presented to the user. The main module, through the dashboard screen, can present Information such as the number of records saved over time. Notifications can also be displayed on the dashboard screen. The dashboard screen may have links to various other screens for capturing information, saving a record, and searching for a record in the database. A menu bar 410 is also shown at the bottom of the dashboard screen for accessing and switching between different screens. The menu bar can be positioned like a floating menu bar which may remain the same in all the screens of the interface and allows navigating between the different screens. The shape and position of the menu bar, however, can vary without departing from the scope of the present invention. A dashboard icon can be linked to the dashboard screen and can be used to open the dashboard screen from anywhere in the interface.

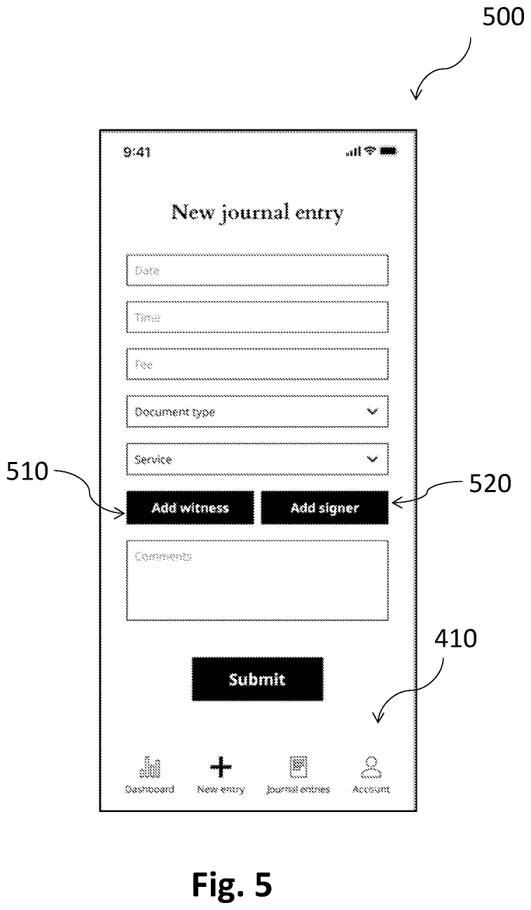

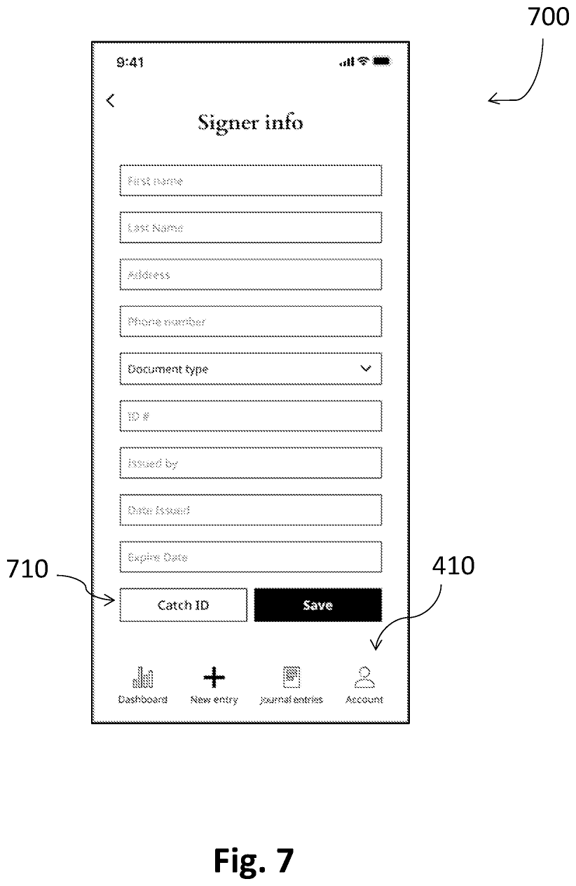

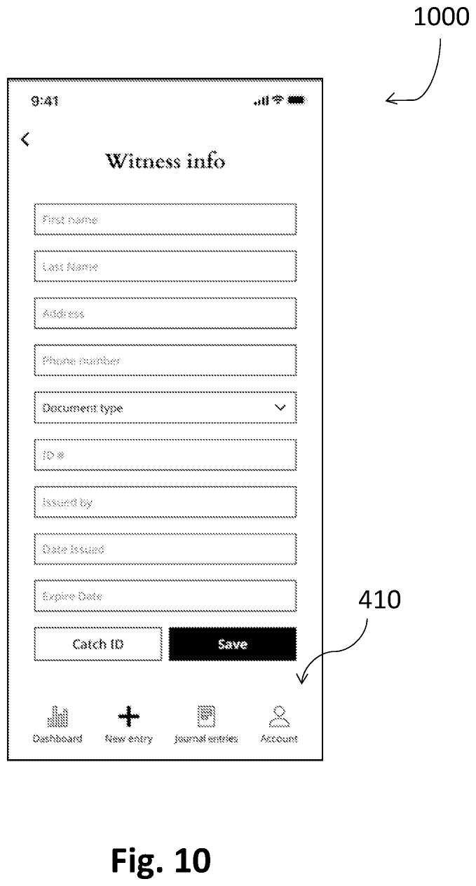

Another icon in the menu i.e., add new entry can open a screen 500 as shown in FIG. 5. Through the screen 500 shown in FIG. 5, the user can enter details of notarization, such as date, time, fee, document, service, and the like. For example, the document type can be an oath, affirmation, Jurat, and acknowledgment. Through the screen 500, the user can enter details of the signer and Witnesses. The screen 500 includes the first soft button 510 to add a witness and a second soft button 520 for adding a signer. Clicking the second soft button 520 results in the opening of screen 700, shown in FIG. 7, to enter the details of a signer. Clicking the first soft button 510 may open a screen 1000 shown in FIG. 10 for adding details of a witness. The main module, through screen 700 and screen 1000 can receive details of the witness and signer. It is to be noted that more than one signer and more than one witness can be added.

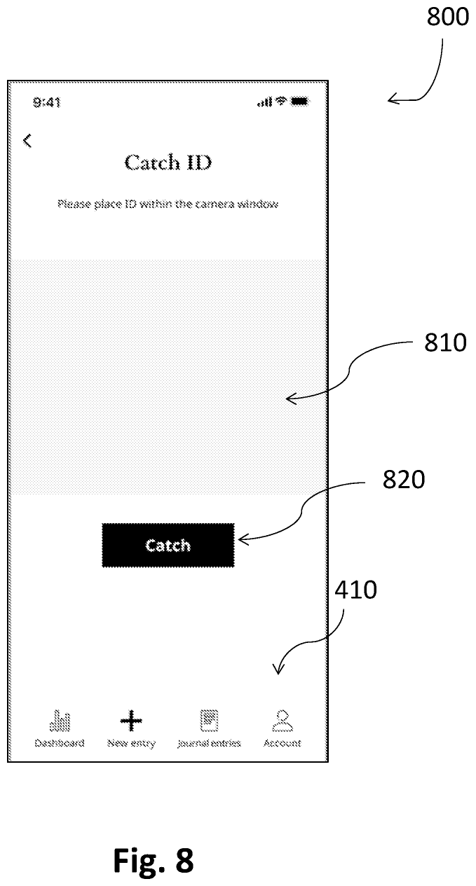

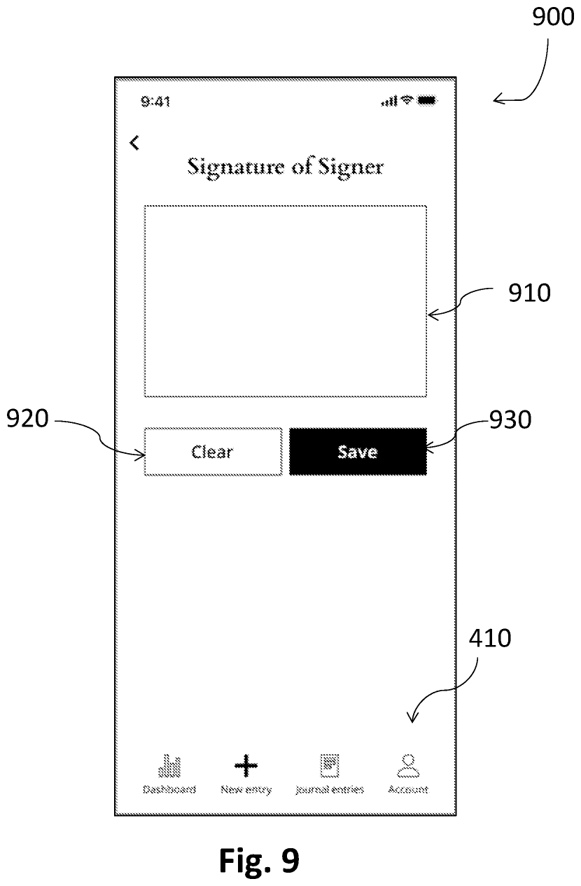

The screen 700 can be used to capture details of a signer. A back arrow can be seen at the top corner that allows reverting to screen 500. The user, through screen 700, can enter the information of the signer including name, address, contact details, and ID provided by the signer. The user can also capture a photograph of the ID using screen 800 shown in FIG. 8. The screen 700 includes a third soft button 710 that opens screen 800 for capturing the ID. Screen 800 has a frame 810 in which an image of ID as captured by a camera of the user device can be displayed. The user can press the catch button 820 to capture the image as shown in frame 810. Once captured, another screen 900 may automatically appear, the screen 900 is shown in FIG. 9. Screen 900 has a frame 910 that can digitally capture the signature of the signer. Button 920 can be used to clear the frame in case of any wrong signature. A save button 930 can save the signature and the screen 500 can then be displayed to the user.

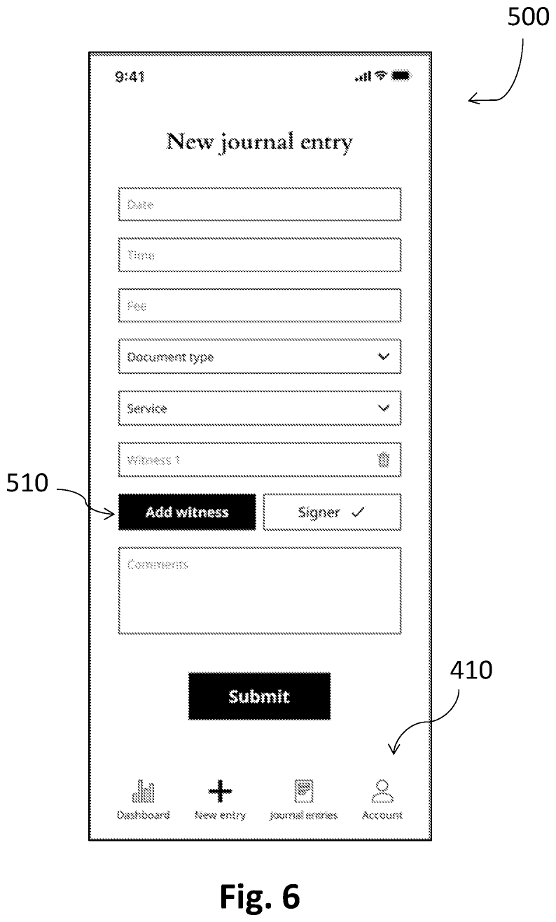

Through the screen 500, the user can add another user or can a witness. The process of adding the witness can be the same as described above for the signer. FIG. 6 shows the screen 500 after adding a witness. Once all the signers and witnesses have been entered by the user, the user can click the submit button to save the record with the disclosed system. The record can be saved by the system in the database. While saving, the user may also optionally enter a comment.

Again, referring to FIG. 5, the menu bar has a third icon which may be linked to screen 1000 shown in FIG. 10. Through screen 1000, the analysis module may allow the user to search records using the name, date, journal ID, and many other keywords. All records matching the search criteria can be displayed through screen 1000. The analysis module may allow checking each of the displayed records through screen 1000. The analysis module may also allow the user to select one or more of the records. The analysis module may also provide an option to export the selected records. The records exported can be printed using a printer attached to the user device. The records can also be exported into different file formats, such as PDF, Word format, images, and the like, and the same can be saved in the memory of the user device using the file system of the user device. The analysis module may also provide to export the records as attachments to an email. The records can also be exported to different network applications, such as WhatsApp, Telegram, and the like.

A fourth icon i.e., the account icon in the menu may open a screen 1100 that may display a profile of the user. The registration module may allow the user to modify details presented through the screen 1100 and save the changes. The record can be signed using digital signatures of the notary public and the signed record can be saved. The record can also be encrypted and signed, for authentication and securing the record against tampering. The record can also be saved as a block in a blockchain, and the same can be saved using the blockchain and public ledger technology. It is to be noted that a copy of the record can also be saved separately which allows searching the records using a variety of ways, such as keywords, date, and the like.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for electronically verifying an identity card and managing an electronic notary journal, the system comprising a processor and a memory, the system configured to implement a method comprising:
creating, a new journal entry, through a first screen of an interface, by receiving details for a document to be notarized, the detail of the document comprises nature of the document and fee;
adding, at least one signer, through a second screen of the interface, wherein details of a first signer of the at least one signer are received through the second screen;
capturing, an image of an identity document of the first signer through a third screen, wherein closing the third screen automatically opens a fourth screen of the interface;
receiving, through the fourth screen, electronically, a signature of the first signer, wherein saving the signature automatically closes the fourth screen and opens the second screen, the second screen shows the added first signer; and
verifying the identity document and the details of a first signer against an external database.

2. The system according to claim 1, wherein the method further comprises:
adding one or more witnesses through a fifth screen of the interface, wherein details of a first witness of the one or more witnesses are received through the fifth screen, an identity document of the first witness is received through the third screen, and a signature of the first witness is electronically received through the fourth screen.

3. The system according to claim 2, wherein the added first signer and the first witness are shown on the second screen.

4. The system according to claim 2, wherein the method further comprises:
verifying the details of the first witness and the identity document of the first witness against the external database.

5. A method for electronically verifying an identity card and managing an electronic notary journal, the method implemented within a system comprising a processor and a memory, the method comprising:
creating, a new journal entry, through a first screen of an interface, by receiving details for a document to be notarized, the detail of the document comprises nature of the document and fee;
adding, at least one signer, through a second screen of the interface, wherein details of a first signer of the at least one signer are received through the second screen;
capturing, an image of an identity document of the first signer through a third screen, wherein closing the third screen automatically opens a fourth screen of the interface;
receiving, through the fourth screen, electronically, a signature of the first signer, wherein saving the signature automatically closes the fourth screen and opens the second screen, the second screen shows the added first signer; and
verifying the identity document and the details of a first signer against an external database.

6. The method according to claim 5, wherein the method further comprises:
adding one or more witnesses through a fifth screen of the interface, wherein details of a first witness of the one or more witnesses are received through the fifth screen, an identity document of the first witness is received through the third screen, and a signature of the first witness is electronically received through the fourth screen.

7. The method according to claim 6, wherein the added first signer and the first witness are shown on the second screen.

8. The method according to claim 6, wherein the method further comprises:
verifying the details of the first witness and the identity document of the first witness against the external database.
